(19) United States
(12) Patent Application Publication
(10) Pub. No.: US 2020/0020028 A1
(43) Pub. Date: Jan. 16, 2020

(54) Risk Reduction Mortgage System and Method

(71) Applicant: RISK REDUCTION MORTGAGE CORPORATION, Manchester, NH (US)

(72) Inventors: Marc Biron, Manchester, NH (US); Monir Mamoun, Manchester, NH (US); Paul C. Mangelsdorf, III, Manchester, NH (US)

(21) Appl. No.: 16/470,087

(22) PCT Filed: Dec. 14, 2017
(86) PCT No.: PCT/US17/66547

§ 371 Date: Jun. 14, 2019

Related U.S. Application Data
(60) Provisional application No. 62/434,346, filed on Dec. 14, 2016.

(51) Int. Cl. G06Q 40/02; G06Q 50/16

(52) U.S. Cl. CPC G06Q 40/025; G06Q 50/163

(57) ABSTRACT

A Risk Reduction Mortgage System and Method is provided. In one aspect of the present disclosure is a system and method of calculating and reducing risk by offering consumers, as a feature of their mortgage transaction, the practical means of trading local price risk as measured by changes in local housing price indices for the performance of the national real estate price risk as measured by a national housing price index. In another aspect, the present disclosure is a method, system, and a computer readable medium for generating and managing a risk reduction mortgage.

### RELATED APPLICATION

Under provisions of 35 U.S.C. § 119(e), Applicant claims the benefit of U.S. provisional application No. 62/434,346 entitled “System and Method for Risk Reduction Mortgage,” filed Dec. 14, 2016, which is incorporated herein by reference.

Under provisions of 35 U.S.C. § 119, Applicant claims the benefit of international application no. PCT/US17/66547, designating the United States, entitled “Risk Reduction Mortgage System and Method,” filed Dec. 14, 2017, which is incorporated herein by reference. This application is filed under provisions of 35 U.S.C. § 371 for National Stage Commencement.

It is intended that each of the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to systems and methods for reducing risk. More specifically, the present disclosure relates to systems and methods for reducing risk in the field of financing real estate mortgages.

### BACKGROUND

A mortgage loan or mortgage is often used by purchasers of real property to raise funds to buy real estate. Mortgages are also used as financial instruments by existing property owners to raise funds for other purposes by placing a lien on the property being mortgaged. A mortgage loan is secured on a borrower's property in a process known as mortgage origination. This mortgage origination creates a legal mechanism that allows the lender to take possession and sell the secured property to pay off the loan in the event that the borrower defaults on the loan or otherwise fails to abide by the loan terms. This process is known as foreclosure or repossession. Another way to describe is mortgage is as a borrower giving consideration in the form of collateral for a loan or benefit.

There are various mortgage products available including conventional loans which allow borrowers to repay a secured mortgage by making regular payments toward the principal and interest over a set term. In the United States of America, this process is known as amortization. Internationally, this process is known as a repayment mortgage or utilizing other terminology. Commonly known mortgage product alternatives to the conventional mortgage include interest only, interest-only lifetime, reverse mortgages, interest and partial principal, balloon loans, and graduated payment mortgage loans.

In many situations, home mortgages represent both the greatest investment and the greatest risk at the same time. For example, purchasing a home requires large down payments and a long term commitment from a home owner. Thus, the conventional strategy is for the homeowner to choose the most affordable home in the best geographic location possible. This often causes problems because the conventional strategy does not account for severe volatility in the residential real estate market. For example, the recession of the last ten years created tremendous hardships, foreclosures, and debt burden on homeowners, lenders, the real estate financial community, and the international economy.

For the greater benefit of the economy and the parties involved in the real estate financial process, there is a need to limit the risk involved with housing transactions. Another conventional strategy is to utilize home equity insurance policies currently on the market. This often causes problems because this conventional strategy does not account for the fact that such products are inherently constrained by the insurer's capital and reinsurance capacity. Moreover, these home equity insurance products are limited in duration and scope. Typically, they are only available for a portion of the value of the property and may have other limitations such as requiring a sale or transfer before payment. Therefore, a new type of product is necessary to reduce the risk associated with home purchases and mitigate the aforementioned problems.

### BRIEF OVERVIEW

A Risk Reduction Mortgage System and Method may be provided. This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

The present disclosure is a system and method of calculating and reducing risk by offering consumers, as a feature of their mortgage transaction, the practical means of trading local price risk as measured by changes in local housing price indices for the performance of the national real estate price risk as measured by a national housing price index.

The material distinguishing feature of the disclosure is that, due to the benefits of diversification of risk, it primarily reduces a homeowner's real estate price risk as opposed to merely transferring risk. This is a novel system and method as there is no existing systems or means for limiting risk in these transactions available in the market.

Moreover, the present disclosure provides a risk reduction mortgage product using a system including a borrower, a mortgage originating institution, a funding partner, a risk reduction swap, a housing price index (HPI). The housing price index (HPI) can be at least one of a local HPI, a national HPI, a calculated HPI based on a mathematical calculation using the local HPI and national HPI. The system includes a risk reduction swap which can be a calculated value of a borrower swap position. The calculated value of the borrower swap position can be determined by, a national loan to value calculation which is the quotient of an ending principal balance and the product of a National HPI Index and Property Value at Origination.

The system can include an estimated property value which is equal to the quotient of the product of the local HPI and an appraised property value at origination. Further, the system can include a calculated swap balance which is equal to the difference of the product of the estimated property value and the national loan to value calculation with the ending principal balance being the subtrahend. Additionally, the system can include the calculated value of the borrower swap position as the difference between a first calculated swap balance and a second calculated swap balance. The first and second calculated swap balance can be current, previous, or other time based calculated swap balances.

The system further including a swap servicer, a mortgage servicer, and Risk Reduction mortgage modules, an HPI Provider, and an HPI data.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure;

FIG. 2 illustrates a block diagram of a general environment consistent with the present disclosure;

FIG. 3 is a flow chart of a method for providing Risk Reduction Mortgage System;

FIG. 4 is a flow chart of a method for providing Risk Reduction Mortgage System;

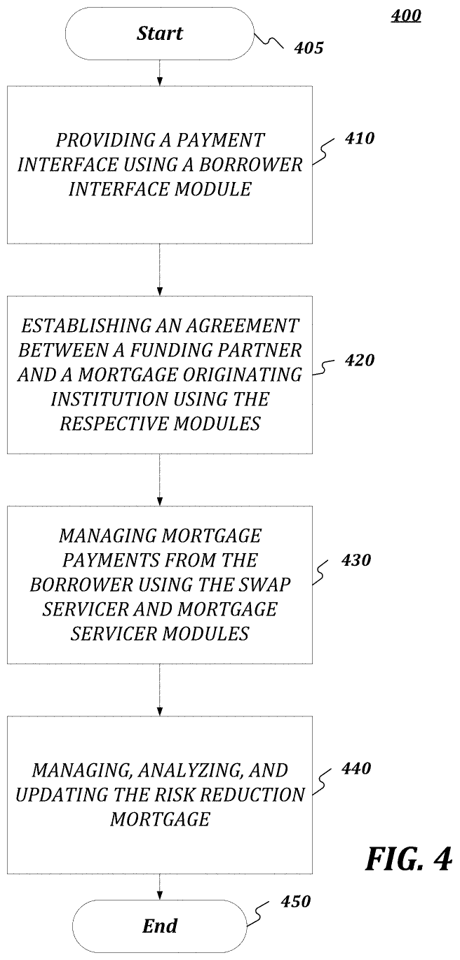

FIG. 5 is a flow chart of a method for providing Risk Reduction Mortgage System; and

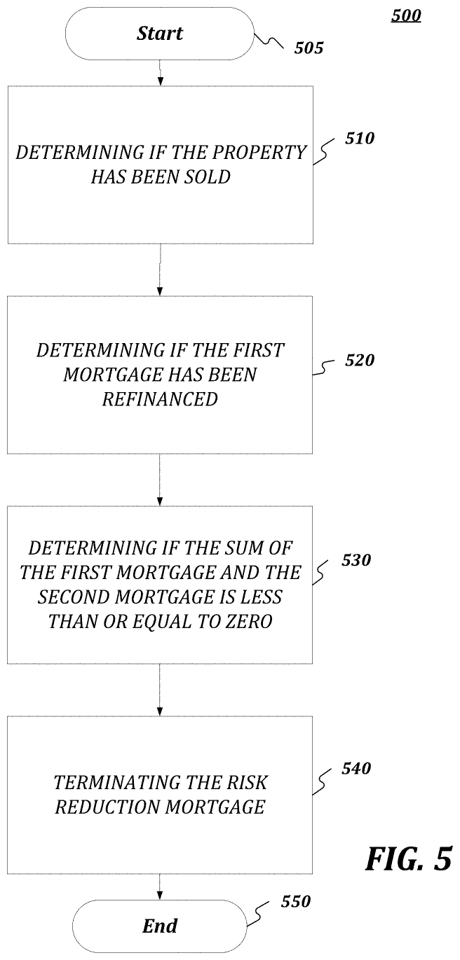

FIG. 6 is a block diagram of a system including a computing device for performing the method of FIG. 3, 4, or 5.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of systems and methods for reducing risk in the field of financing real estate mortgages, embodiments of the present disclosure are not limited to use only in this context.

I. Platform Overview

For many homeowners, their home represents their single largest asset and their mortgage represents their largest debt. As the recent “great” recession demonstrated, there can be dramatic variances in housing price movements in local real estate markets. A review of historical housing price changes by Metropolitan Statistical Areas (MSA) shows that the volatility of residential real estate prices for individual local markets (as measured by standard deviation) is significantly greater than the volatility of residential real estate prices for the overall United States market. The lower real estate price volatility for the overall United States market is a result of the benefit of diversification of risk.

Until now, residential real estate price risk has been unavoidably geographically concentrated for homeowners, as they are exposed to the risk that the value of their home goes up or down in relation to the value of homes in their local area. Homeowners have no practical means to diversify their local residential price risk. Mortgages however do not fluctuate in balance due to residential real estate price changes. Accordingly, during the recent recession, homeowners often found that the equity in their homes had disappeared as their homes lost value. Many homeowners found themselves owing more on their mortgage than the value of the home. This in turn often led to default on the mortgage debt and foreclosure, as many homeowners were unable to sell their homes when financial or other life circumstances required a sale, due to their negative equity position.

In this disclosure, the Risk Reduction Mortgage, provides an instrument and systems that easily allows individual homeowners to efficiently and effectively diversify their residential price risk from local to national. The system and method described in this disclosure significantly reduces the risk through the benefits of diversification. While nothing can completely eliminate housing price risk, no existing product can reduce real estate price risk to the extent that homeowners are able to achieve with this disclosure.

The breakthroughs that have facilitated the systems and methods presented in this disclosure include the creation of national and regional housing price indices, with the leading index being the Case-Shiller Housing Price Indices®, and the development of algorithmic techniques for amassing, tracking, and manipulating data at the instrument level. The most important breakthrough described herein is the creation of a novel swap, a customer-specific instrument that allows consumers to “sell” their local real estate price risk and “buy” national real estate price risk, mediated by a number of technical subsystems connecting participating entities in the system. Based on analysis of historical home price indices data, it is estimated that on average the diversification offered by the disclosure will reduce home price risk across a portfolio by at least 40%.

The present disclosure is a system and method of calculating and reducing home price risk by offering consumers, as a feature of their mortgage transaction, the practical means of trading local price risk as measured by changes in local housing price indices for the performance of the national real estate price risk as measured by a national housing price index.

### Defined Terms

Borrower—An individual consumer who enters into a Risk Reduction Mortgage transaction to finance the purchase of a 1-4 unit residential property, a condominium or a unit in a Planned Unit Development (PUD) or to refinance an existing mortgage.

Funding Partner—For each Risk Reduction Mortgage the entity who will enter into the swap transaction with the respective individual consumer (first mortgagor). The Funding Partner is the counterparty to that swap having swapped national real estate price risk for local real estate price risk. The Funding Partner is typically the primary holder of the credit risk for the underlying mortgage (e.g., GSEs such as FNMA and FHLMC, Financial Institutions such as banks, credit Unions and Savings & Loans, Private Mortgage Insurers) GSE—A government-sponsored enterprise (GSE) is a financial services corporation created by the United States Congress. For this document GSE refers to the two most well-known GSEs, the Federal National Mortgage Association (FNMA), or Fannie Mae, and the Federal Home Loan Mortgage Corporation (FHLMC), or Freddie Mac.

Housing Price Index (HPI)—A Housing Price Index is an economic index that allows for the comparison of changes in housing price over time for a specific geographic area. The best known housing price index is the S&P Case-Shiller Housing Price Index®. That index is calculated using a weighted repeat sales method developed by Karl Case, Robert Shiller and Allan Weiss.

Loan to Value (LTV)—The ratio of a secured loan balance to the value of the underlying collateral.

Local Real Estate Market—For purposes of this disclosure, the local real estate market is defined as the smallest localized market for which sufficient sales data is routinely available to assure that a related housing price index is stable, reliable and consistent. The markets used for this product are shown in the table below displayed by increasing granularity from top to bottom. For this disclosure for any geographic location, the most granular indices which can be statistically demonstrated to meet the stable, reliable and consistent constraints will be used.

TABLE 1

| | | Currently with |
|---|---|---|
| | Number | Available |
| Market Designation | in US | Indices |
| State | 50 | 50 |
| Metropolitan Statistical Area | 388 | 388 |
| Core Based Statistical Area | 929 | 929 |
| County or County Equivalent | 3,142 | 1,300 |
| Zip Code | 41,717 | 7,400 |

Mortgage Originating Institution—A Bank, Credit Union, Savings and Loan or other financial institution authorized and licensed to originate first mortgage loans which institution is also an authorized participant in the Risk Reduction Mortgage program.

Mortgage Servicer—An entity who, with respect to a mortgage or group of mortgages, is with respect to those mortgages, responsible for maintaining the books and records, collecting payments, accounting for all transactions, performing collection and payment-default services as required, providing customer service and providing the cashflow from a mortgage or group of mortgages to the legal owner of the mortgage. The entity that has both the legal right and obligation to service a mortgage or group of mortgages.

National Real Estate Market—For purposes of this disclosure, the National Real Estate market is defined as the real estate market for all the fifty states and the District of Columbia weighted by real estate value and for which an HPI consistent with the Local Real Estate Market HPIs is available.

Origination Data—Origination data is information specific to a new Risk Reduction Mortgage to be provided by Mortgage Originating Institution to the Swap Servicer. This data will include at least one of the following or any combination thereof:
Servicer's unique account number
First mortgage loan amount
Appraised value of property securing loan
Loan term
Monthly payment
Loan Type (fixed rate or ARM)
If Loan Type is ARM, data about structure of the ARM (index, margin, periodic and lifetime caps, frequency of payment change etc.)
Loan interest rate
Loan closing date
First payment due date
Monthly payment date
Credit underwriting data concerning the mortgage including FICO score, Borrower's Income, Co-Borrower's income, combine debt service ratio, housing payment to income ratio etc.
Risk Holder for the mortgage (A financial institution such as a bank, savings or loan or credit union, or a GSE such as FNMA or FHLMC.)
GSE loan identifier (if a GSE loan)
Private mortgage Insurance indicator (y/n)
Private mortgage insurance mortgager
Borrower Name
Co-Borrowers Name
Borrower's mailing address
Co-Borrowers mailing address (if different from Borrower's address)
Mortgage property address (street and number, state and Zip code and county)

Private Mortgage Insurer—Private Mortgage Insurers provide a type of insurance policy to protect a mortgage lender against loss if a borrower defaults. This insurance is called Private Mortgage Insurance (PMI). Most lenders require PMI when a homebuyer makes a down payment of less than 20% of the home's purchase price—or in other words the mortgage's loan to value (LTV) ratio is more than 80%.

Risk Reduction Mortgage—The unique combination of a fully-amortizing conventional first mortgage, an individualized Risk Reduction Swap together with an open-end second mortgage securing the swap and the proprietary inter-party communication system and database that organizes, facilitates the management of and tracks these products.

Risk Reduction Swap—The swap of Local Real Estate Price Risk for National Real Estate Price Risk entered between the consumer (the first mortgagor) and the respective Funding Partner. Where the consumer will swap Local Real Estate Price Risk for National Real Estate Price risk and the Funding Partner will swap National Real Estate Price for Local Real Estate Price Risk relative to a specific first mortgage transaction.

Servicing Data—Servicing data is information about each Risk Reduction Mortgage in a Mortgage Servicer's portfolio, to be provided from the Mortgage Servicer to the Swap Servicer monthly. This data will include information from the prior month including at least the following:
Each Servicer's unique account number for each Risk Reduction Mortgage, for cross-referencing purpose
Ending first mortgage balance
Remaining first mortgage term
All Monthly payments (indicating the amount of each payments was applied to Principal interest, fees, insurance, escrow and if applicable the swap balances
If Loan Type is ARM, any data about changes to the structure of the ARM (index, margin, periodic and lifetime caps, frequency of payment change etc.)
Current loan interest rate
Paid through date
Next payment due date
Current delinquency status
Days past due
Legal/Collection Status (Bankrupt, in Foreclosure, Deceased etc.)
Risk Holder for the mortgage (A financial institution such as a bank, savings or loan or credit union, or a GSE such as FNMA or FHLMC)
GSE loan identifier (if a GSE loan)
Borrower Name
Co-Borrowers Name
Borrower's mailing address (if changed from prior month)
Co-Borrowers mailing address (only if different from Borrower's address and if changed from prior month)
Mortgage property address (street and number, state and Zip code and county)

Swap Servicer—An entity formed for the purpose of making a market for Risk Reduction Mortgages, promoting the Risk Reduction Product, entering into Funding Agreements with Funding Partners, authorizing Mortgage Originating Institution(s) and for providing developing, maintaining and providing, to all related parties including the Mortgage Originating Institution(s), Mortgage Servicer(s) and Funding Partner(s), information, data reporting and systems support required to originate, service and track Risk Reduction Mortgages.

### Calculations

To determine the calculated balance of the Borrower's swap position for any period n, where n is a positive integer equal to the number of full months since the mortgage origination, requires the following calculations (or any set of calculations which are the mathematical equivalent). Conversely, the Funding Partner's swap position will be the negative value of the Borrower's swap position, such that for any period the sum of the Borrower's swap position and the Funding Partner's swap position will be equal to $0.00. For example, if the Borrower's calculated swap position were equal to $1,500.00 the Funding Partner's Swap position would be ($1,500.00).

The value of the Borrower's swap position is calculated as follows:
1. Calculate the current Loan to Value based on the national HPI Index (or, the National LTVₙ) according the formula below:

$$\frac{Ending Principal {Balance}_{n}}{\begin{matrix}( National HPI {Index}_{n} / National HPI {Index}_{0} ) ⋆ \\ Property Value at Origination\end{matrix}}$$

2. Then determine the Estimated Property Value for the same period (or, Estimated Property Valueₙ) where the estimated property value for as of period n is equal to:

(Local HPIₙ/Local HPI₀)*Appraised Property Value at Origination
3. Then the calculated swap balance for period n is equal to

Estimated Property Valueₙ*National LTVₙ−Ending Principal Balanceₙ

Accordingly, the monthly change in the Borrower's swap position can be calculated for any period n by subtracting the calculated swap balance for period n−1 from the calculated swap balance for period n.

### Risk Reduction Mortgage

The Risk Reduction Mortgage can be the unique combination of one or more of:
A fully-amortizing conventional first mortgage used to fund the purchase of a property or to refinance an existing first mortgage which meets the criteria described in items 2-4 in the Origination section below.
A simultaneously originated Risk Reduction Swap between the Borrower and a Funding Partner such that the consumer will swap Local Real Estate Price Risk for National Real Estate Price risk and the Funding partner will swap National Real Estate Price for Local Real Estate Price Risk relative to the value of the mortgaged property and in relation to the specific first mortgage and including the terms described in Items 5-9 in the Origination section below and subject to monthly systematic determination of the swap position for both the Borrower and the Funding Partner using the calculations described in the Calculations section above.
An open-end second mortgage between the Borrower and the Funding Partner including the terms and features described in Items 10-14 in the Origination section below, and further subject to monthly systematic determination of the second mortgage swap position for both the Borrower and the Funding Partner based upon changes to the swap position determined using the calculations described in the Calculations section above.
An agreement restricting the servicing rights and obligations of the second mortgage as described in item 15 of the Origination section below.

The combination of the above products and features may be implemented using a proprietary computer platform, system and databases that receive origination data and servicing data and periodic updates to all the HPI indices used to value Risk Reduction Swaps as well as maintaining all historical data values of all the above data. The system may also include algorithmic calculations to determine the appropriate Local Market HPI for the subject property, and periodic calculations of the Borrower's and Funding Partner's swap value based on the first mortgage balance, the appraised value of the subject residential property and relative changes in value of the relevant Local Market HPI and the National Market HPI by use of instructions for the formulas in the Calculation section above in a computer readable storage medium, increasing or decreasing the second mortgage loan balance based on the relative price movement of the two indices.

The computer system, in an automated fashion, may also determine and track payments related to the second mortgage. The system may also include all reporting and tracking for Mortgage Originating Institutions, Mortgage Servicer(s) and Funding Partner(s) to track the accounting necessary for the transactions and to manage their respective portfolios. The computing system, platform, operating environment, implementation and other aspects of the system and method are detailed in subsequent sections of this disclosure.

### Risk Reduction Mortgage Product Options

The Risk Reduction Mortgage may include various product options each with the same swap based risk-reducing national diversification feature. The products are the same in all respects except for the repayment of any positive balance of the second mortgage (the terms of which are described in detail in the Origination section below). The consumer will select the option of their choice prior to closing.

In a first option the consumer makes principal payments on the second mortgage balance during the life of the first mortgage. If the local real estate market outperforms the national real estate market, the borrower's swap balance will be positive (greater than $0.00), and the second mortgage will have a similar positive balance. At the end of the first year after the origination of the Risk Reduction Mortgage, and every six or twelve months thereafter, (as determined at origination by agreement between the consumer and the Funding partner), a payment determination will be made. If, at the time of the payment determination, the balance of the second mortgage is positive a monthly principal payment will be determined equal to the greater of $25.00 or the balance of the second mortgage divided by the remaining term of the first mortgage. The consumer will make the monthly principal payments on the second mortgage until the balance of the second mortgage is zero or another payment is determined. If, at the time of the payment determination, the balance of the second mortgage is zero or negative the monthly principal payment will be determined to be $0.00.

In a second option the customer may make no principal payments on the second mortgage during the life of the first mortgage. If, and when, the first mortgage has been fully paid in the normal course of business (not resulting from a refinancing or a sale of the underlying property) and the consumer's second mortgage balance is greater than $0.00, two things may happen:
The second mortgage, which previously may have had a 0.00% interest rate, will begin accruing interest at a fixed interest rate set equal to the then 5-year treasury yield plus a margin.
The consumer must begin monthly repayment of the second mortgage at a level principal and interest payment set to fully amortize the loan at the determined interest rate over a fixed term. The term of the repayment will be based upon the balance of the second mortgage, but will not exceed ten years.

### Aspects

The following disclose various Aspects of the present disclosure. The various Aspects are not to be construed as patent claims unless the language of the Aspect appears as a patent claim. The Aspects describe various non-limiting embodiments of the present disclosure.

### A Risk Reduction Mortgage Implementation

The mechanism to implement the product requires a novel combination of financial products available in the market today along with a novel swap transaction, a complex ecosystem of product participants and a sophisticated custom computer system to track and monitor the product at the individual consumer level as well as at the portfolio level.

The following are the steps to originate and service the product for each individual customer.

### Origination

Aspect 1. The consumer elects to obtain the Risk Reduction Mortgage product in conjunction with a new mortgage transaction.

Aspect 2. The new mortgage can be either a purchase money mortgage transaction of a refinance of an existing mortgage.

Aspect 3. To be eligible for the Risk Reduction Mortgage transaction the first mortgage must be a fully-amortizing conventional mortgage (no balloon structures, negative amortization or irregular payment schedules are permitted). The first mortgage must require monthly payments.

Aspect 4. The first mortgage can be either a fixed rate mortgage or an ARM. The mortgage must have an original term of between 120 to 360 months.

Aspect 5. Concurrent with the closing of the first mortgage the consumer will enter into a Risk Reduction Swap transaction with the respective Funding Partner for that loan. The Risk Reduction Swap will be structured to swap Local Real Estate Market price risk for National Real Estate Market price risk.

Aspect 6. The Risk Reduction Swap will be structured so that the value of the swap will change based upon the relative changes to the relevant Local Real Estate Market HPI and the National Real Estate Market HPI such that in any month if the sum of the consumer's first mortgage balance and their swap value is compared to the current estimated property value (estimated by multiplying the appraised property value at loan origination by one (1) plus the percentage change in the Local Real Estate Market HPI since origination) would result in an LTV equal to the hypothetical LTV if the value of the property had changed proportionately to the National Real Estate Market HPI rather than the Local Real Estate Market.

Aspect 7. The Risk Reduction Swap will be designed and structured such that at any point during its life either counterparties swap value can be either positive or negative. The initial value of the swap will be $0.00 for each party.

Aspect 8. After origination, the value of the Risk Reduction Swap will be determined monthly based upon changes in the Local Real Estate Market HPI and the National Real Estate HPI in the prior month as measured by the respective Local HPI and the National HPI.

Aspect 9. The Risk Reduction Swap will have a mandatory termination and settlement concurrent with: any transaction to sell or transfer the underlying property; if the first mortgage is refinanced or; if the sum of the first mortgage balance and the second mortgage securing the consumer's obligations under the swap is less than or equal to $0.00.

Aspect 10. The consumer's financial obligations arising from the Risk Reduction Swap will be secured be an open-end second mortgage which will be closed concurrently with the first mortgage. The Funding Partner or their designee will be the owner of the second mortgage.

Aspect 11. The second mortgage will initially have a balance equal to $0.00. The second mortgage balance will be increased in any month by the amount equal to any calculated increase in the consumer's swap value in the prior month or resulting from the settlement of the swap. The second mortgage balance will be decreased in any month by the amount equal to any calculated decrease in the consumer's swap value in the prior month, by any principal payments made by the consumer on the second mortgage, or resulting from the settlement of the swap.

Aspect 12. The second mortgage securing the Risk Reduction Swap will have an interest rate equal to 0.00% unless the consumer's second mortgage balance is greater than $0.00, and the first mortgage has been fully paid in the normal course of business (not resulting from a refinancing). When such a full repayment occurs the second mortgage will begin accruing interest at a fixed interest rate set equal to the then 5-year treasury yield plus a margin.

Aspect 13. If the second mortgage becomes interest accruing, as described above, the consumer must begin monthly repayment of the second mortgage at a payment set to fully amortize the loan at the determined interest rate and over a term based upon the balance of the second mortgage, but not to exceed ten years.

Aspect 14. The second mortgage will be carried on the Mortgage Servicer(s) books and records as a memo posted account and no cash transactions will be posted against those accounts.

Aspect 15. At the closing there will be an agreement entered into by the Mortgage Originating Institution and the Funding Partner tying the servicing of the first mortgage to the servicing of the second mortgage and requiring that the servicing cannot be separated. The agreement will also require all subsequent owners/servicers to provide to the Swap Servicer as applicable, Origination Data at origination and Monthly Servicing Data on monthly basis.

Aspect 16. No cash will be exchanged with respect to the Risk Reduction Swap except in the instance of a mandatory settlement, or if the consumer elects to make payments against a positive second mortgage balance while the first mortgage still has a balance or from a monthly principal payment for the second mortgage when the second mortgage is in amortization.

Aspect 17. At closing the Mortgage Originating Institution will collect a Risk Reduction Mortgage origination fee due to the Swap Servicer.

### Post-Closing

Aspect 1. The Mortgage Originating Institution will transmit the Origination Data to the Swap Servicer.

Aspect 2. The Mortgage Originating Institution will transmit electronic copies of all relevant documents including the first mortgage note, the swap agreement, the 2^{nd} mortgage note, evidence that the second mortgage was recorded and is in 2^{nd} lien position and the agreement referred to in number 15 of the origination section above.

Aspect 3. The Mortgage Originating Institution will transfer the origination fee referred to in number 17 or the origination section above.

Aspect 4. The Swap Servicer will confirm that the documents provided by the Mortgage Originating Institution are complete and correct and that none of the required documents is missing.

Aspect 5. The Swap Servicer will confirm that the data transmitted in the Origination Data is consistent with the documents provided for in Post-Closing Item 2 above.

Aspect 6. The Swap Servicer will enter the Origination Data into the Swap Servicing System.

### Monthly Servicing

Aspect 1. The Swap Servicer will obtain updated HPI values for all Local Markets and for the National Market and update their databases and systems.

Aspect 2. The Mortgage Servicer(s) will transmit their respective Servicing Data file(s) to the Swap Servicer.

Aspect 3. To the extent practicable, the Swap Servicer will validate that the Servicing Data is complete and correct.

Aspect 4. The Swap Servicer will update their databases and systems with the Servicing Data file(s) provided by the Mortgage Servicer(s).

Aspect 5. The Swap Servicer will transmit to the respective Mortgage Servicer(s) information about each of their customer's Risk Reduction Swap values and their respective second mortgages. This information will include original property value, original Local Real Estate Market HPI and National Real Estate Market HPI values, prior period Local Real Estate Market HPI and National Real Estate Market HPI values, current period Local Real Estate Market HPI and National Real Estate Market HPI values, prior period second mortgage balance, current period change in second mortgage balance due to change in the consumer's swap position, any other changes to the second mortgage balance due to payments received and the current period second mortgage balance.

Aspect 6. The Swap Servicer will produce reports for each Mortgage Servicer designed to support any Mortgage Servicer monthly settlement activities, to provide detailed account-level and summary portfolio reporting for each Mortgage Servicer's Risk Reduction Mortgage servicing portfolio, both as a whole and by Funding Partner(s).

Aspect 7. The Swap Servicer will provide notification to each Mortgage Servicer for any Risk Reduction Mortgage where the sum of the first mortgage balance and the second mortgage balance is less than or equal to $0.00, so that the Mortgage Servicer may timely process the closing of those accounts and the release of each of the first and second mortgage liens.

Aspect 8. The Swap Servicer will provide reporting to the Funding Partner(s) on their individual Risk Reduction Swap transactions and the respective second mortgages. This information will include, but not be limited to, original property value, original Local Real Estate Market HPI and National Real Estate Market HPI values, prior period Local Real Estate Market HPI and National Real Estate Market HPI values, current period Local Real Estate Market HPI and National Real Estate Market HPI values, prior period second mortgage balance, current period change in second mortgage balance due to change in the consumer's swap position, any other changes to the second mortgage balance due to payments received and the current period second mortgage balance.

### Swap Settlement—Sale of Property

Aspect 1. In the event the borrower sells the property, the Mortgage Servicer will provide the closing agent with a payoff quote for both the first and the second mortgages. The Swap Servicer will facilitate the transfer of fund to or from the closing agent depending on whether the second mortgage has a negative or positive balance.

Aspect 2. The Swap Servicer will update its system to reflect the settlement of the Swap and will provide documentation to the Borrower and the Funding Partner indicating that the Swap has settled in full.

### Swap Settlement—First Mortgage Refinance

Aspect 1. In the event the borrower refinances the first mortgage, Mortgage Servicer will provide the closing agent with a payoff quote for both the first and the second mortgages. The Swap Servicer will facilitate the transfer of funds to or from the closing agent depending on whether the second mortgage has a negative or positive balance.

Aspect 2. The Swap Servicer will update its system to reflect the settlement of the Swap and will provide documentation to the Borrower and the Funding Partner indicating that the Swap has settled in full.

Swap Settlement—Combined First Mortgage Balance and Second Mortgage less than $0.00

Aspect 1. In the event that, as part of its monthly processing the Swap Servicer notified a Mortgage Servicer that a Risk Reduction Mortgage exists where the sum of the first mortgage balance and the second mortgage balance is less than or equal to $0.00 because the second mortgage had a sufficiently large negative balance to offset the first mortgage balance, the Swap Servicer will facilitate the transfer of funds to the Mortgage Servicer.

Aspect 2. The Mortgage Servicer will use the funds to pay-off the first mortgage.

Aspect 3. The Mortgage servicer will timely process the closing of those accounts and the release of each of the first and second mortgage liens.

Aspect 4. The Swap Servicer will update its system to reflect the settlement of the Swap and will provide documentation to the Borrower and the Funding Partner indicating that the Swap has settled in full.

### Swap Settlement—With Payment Option 1 and Repayment of Mortgage in Full in the Normal Course of Business

Aspect 1. If the Borrower had elected payment option 1 described in the Product Options section above, the borrower would have been making payments towards any positive second mortgage principal over the life of the loan.

Aspect 2. Each month the Swap Servicer would have received payments for the second mortgage from the Mortgage Servicer, adjusted the balance of the swap and remitted the funds to the Funding Partner. For this option the payments should be such that the Second Mortgage (and accordingly the swap) would pay-off concurrent with the first mortgage.

Aspect 3. When the Swap Servicer is notified that the first mortgage has paid in full and has confirmed that sufficient payments have been received to pay the swap balance in full the Swap Servicer will update its system to reflect the settlement of the Swap and will provide documentation to the Borrower and the Funding Partner indicating that the Swap has settled in full.

Swap Settlement—with Payment Option 2 and Repayment of Mortgage in Full in the Normal Course of Business

Aspect 1. If the Borrower had elected payment option 2 described in the Product Options section above, the borrower would begin making level monthly payments to pay any positive second mortgage balances. These payments are determined under the terms of the second mortgage.

Aspect 2. Each month the Swap Servicer would have received payments for the second mortgage from the Mortgage Servicer, adjusted the balance of the swap and remitted the funds to the Funding Partner. For this option the payments should be such that the Second Mortgage (and accordingly the swap) would pay-off concurrent with the first mortgage.

Aspect 3. When the Swap Servicer is notified that the second mortgage has paid in full and has confirmed that sufficient payments have been received to pay the swap balance in full the Swap Servicer will update its system to reflect the settlement of the Swap and will provide documentation to the Borrower and the Funding Partner indicating that the Swap has settled in full.

### Risk Reduction Mortgage Options and Variations

Aspect 1. In a First variation a borrower or homeowner is offered a one-time balance adjustment to hedge the risk that the zip-code or other sub-index and national indices will go down in tandem. This one-time balance adjustment may be modeled as a “Put” Option offered to the homeowner. It may also be modeled as an irrevocable standby purchase option agreement which guarantees the effective purchase of the home at the current mortgage balance. In addition a “swaption,” “swap-tion,” or “swap-option”format variation may trigger the option to activate this swap and underlying Risk Reduction Mortgage.

Aspect 2. A Second variation may be a collared variation of the Risk Reduction Mortgage where the upside or downside change in balance is limited to a fixed percentage. This variation may be based on a fixed rate, a fixed percentage, a predetermined limit, a predetermined threshold, or other factor. This variation may also be calculated as a result of any of the indices, inputs, or data associated with the Risk Reduction mortgage. In another aspect of this variation, the swap risk may be “collared” symmetrically or asymmetrically, providing a floor to any loss and ceiling to any gain by the homeowner or borrower.

Aspect 3. In a Third variation, difficult to insure properties may be considered with the Risk Reduction Mortgage. In an aspect, catastrophic property losses (e.g. hurricane, earthquake, tornado, wildfires, floods or other disasters) may be synthetically and systematically indemnified by means of diversifying zip code risk. In another aspect, risk associated with disastrous events affecting property losses may be effectively reduced utilizing the Risk Reduction Mortgage.

I. Platform Overview

Consistent with embodiments of the present disclosure, methods, computer-readable media, and systems (also referred to herein as “platform” or Risk Reduction Mortgage platform) for providing, analyzing, tracking, and determining a Risk Reduction Mortgage may be provided. This overview is provided to introduce a selection of concepts in a simplified form that are further described below. This overview is not intended to identify key features or essential features of the claimed subject matter. Nor is this overview intended to be used to limit the claimed subject matter's scope. The Risk Reduction Mortgage System and Method may be used by individuals or companies to calculate and reduce home price risk by offering consumers as a type of mortgage product. Thus according to aspects, the present disclosure provides methods, systems, and/or techniques for managing, organizing, analyzing, adjusting, calculating, determining, processing, and storing values, payments, HPI and mortgage data relating to financing real estate mortgages. This disclosure provides for complex methods of reducing risk associated with real estate mortgage transactions.

In another aspect, the present disclosure provides a system for providing a risk reduction mortgage, receiving, managing, analyzing, determining, correlating, sorting, categorizing, organizing, and providing HPI and mortgage data relating to financing real estate mortgages. The disclosure provides for a method of reducing risk associated with mortgage transactions.

In another aspect, the system may comprise a platform which performs functions associated with at least one of: a server, a borrower interface module, application modules, and external datasets. The disclosure provides for a method for analyzing, calculating, determining, and reducing risk associated with mortgages and real estate financial products.

Consistent with embodiments of the present disclosure, a system may comprise a platform, application modules, a borrower interface module, a server, and external data is presented. The Application modules may comprise a Mortgage Originating Institution module, a Funding Partner module, a Risk Reduction Swap module, a Swap Servicer module, a Mortgage module, a Mortgage Servicer module, a HPI module, and a Risk Reduction Mortgage module. The server may comprises a computer, a processor, a network connection, a memory, HPI data, Swap data, Risk Reduction Mortgage data, servicing data, origination data, mortgage data, and other data. Consistent with embodiments of the present disclosure, a brief overview of each of the elements, components and/or modules is provided below.

1. A computer readable medium comprising, but not limited to, at least one of the following:
I. A Borrower Interface module;
II. A Mortgage Originating Institution module;
III. A Funding Partner module;
IV. A Risk Reduction Swap module;
V. A Swap Servicer module;
VI. A Mortgage module;
VII. A Mortgage Servicer module; and
VIII. A HPI module; and
IX. A Risk Reduction Mortgage module.

Although modules are disclosed with specific functionality, it should be understood that functionality may be shared between modules, with some functions split between modules, while other functions duplicated by the modules. Furthermore, the name of the module should not be construed as limiting upon the functionality of the module. Moreover, each stage in the claim language can be considered independently without the context of the other stages. Each stage may contain language defined in other portions of these specifications. Each stage disclosed for one module may be mixed with the operational stages of another module. Each stage can be claimed on its own and/or interchangeably with other stages of other modules. The following disclosure will detail the operation of each module, and inter-operation between modules.

### A Borrower Interface Module 102

FIG. 100 illustrates one possible operating environment through which a platform consistent with embodiments of the present disclosure may be provided. By way of non-limiting example, a risk reduction mortgage platform 100 may be hosted on a centralized server 110, such as, for example, a cloud computing service. A user 105 may access platform 100 through a software application. The Borrower Interface module 102 allows a borrower to interact with the risk reduction mortgage platform 100. The software application may be embodied as, for example, but not be limited to, a website, a web application, a desktop application, and a mobile application compatible with a computing device 600. One possible embodiment of the software application may be provided by the Risk Reduction Mortgage™ suite of products and services provided by Risk Reduction Mortgage Corporation.

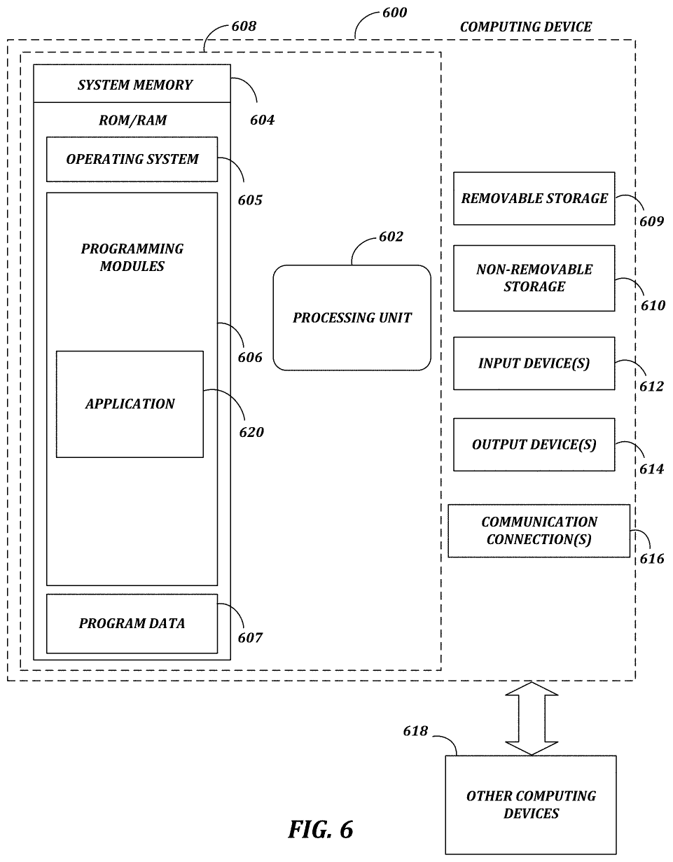

As will be detailed with reference to FIG. 6 below, the computing device through which the platform may be accessed may comprise, but not be limited to, for example, a desktop computer, laptop, a tablet, or mobile telecommunications device. Though the present disclosure is written with reference to a mobile telecommunications device, it should be understood that any computing device may be employed to provide the various embodiments disclosed herein.

### A Mortgage Originating Institution Module 190

The system receives data from Mortgage Originating Institution which is at least one of a Bank, Credit Union, Savings and Loan or other financial institution authorized and licensed to originate first mortgage loans and also is an authorized participant in the Risk Reduction Mortgage program. The data can be received, managed, processed and analyzed by the mortgage originating institution module 190.

### A Funding Partner Module 115

The system receives data from the funding partner which is the entity, for each Risk Reduction Mortgage, that enters into the swap transaction with the respective borrower, individual consumer, first mortgagor, or other entity. The Funding Partner is the counterparty to that swap having swapped national real estate price risk for local real estate price risk. The Funding Partner is typically the primary holder of the credit risk for the underlying mortgage (e.g., GSEs such as FNMA and FHLMC, Financial Institutions such as banks, credit Unions and Savings & Loans, Private Mortgage Insurers). The funding partner provides data to the platform via the funding partner module. The data associated with the funding partner is stored, managed, transmitted, received, and processed using the funding partner module 115.

### A Risk Reduction Swap Module 125

The system receives data from the risk reduction swap transaction at the risk reduction swap module. The risk reduction swap is the swap of Local Real Estate Price Risk for National Real Estate Price Risk entered between the borrower, consumer, the first mortgagor, or other entity and the respective Funding Partner. Where the consumer will swap Local Real Estate Price Risk for National Real Estate Price risk and the Funding Partner will swap National Real Estate Price for Local Real Estate Price Risk relative to a specific first mortgage transaction. The data associated with the risk reduction swap is stored, managed, transmitted, received, and processed using the risk reduction swap module 125.

### A Swap Servicer Module 140

The swamp servicer is the entity formed for the purpose of making a market for Risk Reduction Mortgages, promoting the Risk Reduction Product, entering into Funding Agreements with Funding Partners, authorizing Mortgage Originating Institution(s) and for providing developing, maintaining and providing, to all related parties including the Mortgage Originating Institution(s), Mortgage Servicer(s) and Funding Partner(s), information, data reporting and systems support required to originate, service and track Risk Reduction Mortgages. The data associated with the swap servicer is stored, managed, transmitted, received, tracked, serviced and processed using the swap servicer module 140.

### A Mortgage Module 120

The mortgage module 120 includes information associated with a first mortgage and a second mortgage negotiated and agreed upon by the Borrower 105 and the Mortgage Originating Institution module 190. In some embodiments, the mortgage module 120 also manages, stores, transmits, or submits the Servicing Addendum Data 130 which is generated as a result of addenda negotiated and agreed upon by the Funding Partner and Mortgage Originating Institution necessary to facilitate the risk reduction mortgage. In some embodiments, the mortgage module 120 also manages, stores, transmits, or submits the origination data 135 to the swap servicer module. Origination data 135 is information specific to a new Risk Reduction Mortgage to be provided by Mortgage Originating Institution to the Swap Servicer. The data associated with the mortgage, first mortgage, second mortgage, combination thereof, or other mortgage is stored, managed, transmitted, received, tracked, serviced and processed using the mortgage module 190.

### A Mortgage Servicer Module 180

The mortgage servicer is the entity who, with respect to a mortgage or group of mortgages, is with respect to those mortgages, responsible for maintaining the books and records, collecting payments, accounting for all transactions, performing collection and payment-default services as required, providing customer service and providing the cashflow from a mortgage or group of mortgages to the legal owner of the mortgage. The entity who has both the legal right and obligation to service a mortgage or group of mortgages. The data associated with the mortgage servicer is stored, managed, transmitted, received, tracked, serviced and processed using the mortgage servicer module 180. The Mortgage Servicer module 180 may provide, transmit, send, submit, and deliver Servicing Data 185 to the Swap Servicer Module 140.

### An HPI Module 145

A Housing Price Index is an economic index that allows for the comparison of changes in housing price over time for a specific geographic area. The best known housing price index is the S&P Case-Shiller Housing Price Index®. That index is calculated using a weighted repeat sales method developed by Karl Case, Robert Shiller and Allan Weiss. The HPI data 150 associated with the HPI provider is stored, managed, transmitted, received, tracked, serviced and processed using the HPI module 145.

### A Risk Reduction Mortgage Module 160

The Risk Reduction Mortgage is the novel combination of a fully-amortizing conventional first mortgage, and the individualized Risk Reduction Swap together with an open-end second mortgage securing the swap and the proprietary inter-party communication system and database that organizes, facilitates the management of and tracks these products. The Risk Reduction Mortgage module 160 may include a HPI Database 165, a Swap Database 170, and a Mortgage Database 175. A Risk Reduction Mortgage module 160 may be hosted on a centralized server 110, such as, for example, a cloud computing service.

Various hardware components may be used at the various stages of operations follow the method and computer-readable medium claims. For example, although the methods have been described to be performed by a computing device, it should be understood that, in some embodiments, different operations may be performed by different networked elements in operative communication with the computing device. For example, server 110 and/or computing device 600 may be employed in the performance of some or all of the stages disclosed with regard to the methods claimed below. Similarly, apparatus 160 may be employed in the performance of some or all of the stages of the methods. As such, apparatus 160 may comprise at least those architectural components as found in computing device 600.

Although the stages are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the without altering or deterring from the fundamental scope of the depicted methods and systems disclosed herein.

Finally, the claims are not structured in the same way non-provisional claims are structured. For example, indentations indicate optional/dependent elements of a parent element. Additionally, there may be variations wherein operations can be run in parallel or in alternative embodiments.

A computer-readable medium, comprising:
A memory;
A processor;

Further comprising a set of instructions which when executed is configured to enable a method comprising:
1. Generating a new mortgage by at least one of: a borrower interface module, a mortgage module, a mortgage originating institution module, and a risk reduction mortgage module;
   a. Wherein the new mortgage is at least one of: a conventional mortgage transaction, a purchase money mortgage transaction, and a refinance mortgage transaction;
   b. Wherein the new mortgage comprises a property value;
2. Determining whether the new mortgage is eligible to become a risk reduction mortgage;
   a. Wherein determining is at least one of the following:
      i. a conventional mortgage transaction;
         1. Wherein the conventional mortgage requires monthly payments;
         2. Wherein the conventional mortgage has a term at least one of:
         a. 120 months;
         b. Greater than 120 months;
         c. Less than 360 months;
         d. 360 months; 3. Generating a risk reduction mortgage by at least one of:
   a. a borrower interface module,
   b. a mortgage module,
   c. a mortgage originating institution module,
   d. a funding partner module,
   e. a risk reduction swap module,
   f. a swap servicer module,
   g. a mortgage servicer module, and
   h. a risk reduction mortgage module;
   i. wherein the risk reduction mortgage comprises:
      i. a term of at least one of:
         1. 120 months;
         2. Greater than 120 months;
         3. Less than 360 months;
         4. 360 months;
      ii. A first mortgage wherein the first mortgage is a conventional mortgage requiring a monthly payment for the duration of the term;
      iii. A second mortgage;
         1. Wherein the second mortgage is tied to the first mortgage in a risk reduction swap;
4. Entering a risk reduction swap transaction with a funding partner module;
   a. Wherein the risk reduction swap transaction swaps a local real estate market price risk for a national real estate price risk;
   b. Wherein the risk reduction swap transaction changes relative to at least one of a local HPI data and a national HPI data;
      i. Wherein the relative change is determined by a comparison of a first mortgage balance and an estimated current property value;
         1. Wherein the estimated current property value is the product of an appraised property value at a loan origination and one plus a percentage change in the local HPI since the loan origination;
         2. Wherein the estimated current property value is the product of an appraised property value at the loan origination and one plus a percentage change in the national HPI since the loan origination;
      ii. Wherein the risk reduction swap transaction is stored in the risk reduction swap module;
      iii. Wherein the risk reduction swap transaction is a non-tradable private swap;
      iv. Wherein the risk reduction swap is either positive, negative, or zero;
      v. Wherein an initial risk reduction swap value is a zero dollar value.
5. Determining, by the risk reduction swap module, a risk reduction swap value;
   a. Wherein the risk reduction swap value is determined monthly;
   b. Wherein the risk reduction swap value is determined based on changes to the local HPI and national HPI in a prior month respective to stored local HPI and national HPI data;
   c. Wherein the local HPI and national HPI data is retrieved from a HPI module;
   d. Wherein the stored local HPI and national data is located in the HPI database of the risk reduction mortgage module;
6. Determining, by the risk reduction swap module, a termination of the risk reduction swap upon the occurrence of at least one of;
   a. A sale of the property;
   b. A transfer of the property;
   c. A refinance of the first mortgage;
      i. Whenever the sum of the first mortgage and second mortgage is equal to one of: less than zero or zero;
7. Securing, by a funding partner module, the risk reduction swap provided, by the risk reduction swap module;
   a. Wherein securing comprises an open-end second mortgage;
   b. Wherein securing comprises the funding partner module determining ownership of the open-end second mortgage;
      i. Wherein determining ownership includes assigning ownership to one of the funding partner module or a designee of the funding partner module;
   c. Wherein securing comprises a second mortgage;
8. Setting, by a mortgage module, a second mortgage balance;
   a. Wherein the second mortgage balance is a determined value;
   b. Wherein the second mortgage balance is initially zero;
   c. Wherein the second mortgage comprises a determined interest rate;
      i. Wherein the determined interest rate is zero;
      ii. Wherein the determined interest rate is a fixed rate;
      iii. Wherein the determined interest rate is equal to a five-year treasury yield plus a margin;
9. Increasing the second mortgage balance by an amount equal to a calculated increase in the risk reduction swap value in a prior month;
   a. Wherein the increase is a result of a settlement of the risk reduction swap;
10. Decreasing the second mortgage balance by an amount equal to a calculated decrease in the risk reduction swap value in a prior month;
   a. Wherein the decrease is a result of a settlement of the risk reduction swap;
11. Setting, by the mortgage module, a second mortgage payment;
   a. Wherein the second mortgage payment is determined based on a fully amortized loan at the determined interest rate and a term;
   b. Wherein the term is a number of years;
   c. Wherein the number of years is determined by a calculation based on the second mortgage balance and the determined interest rate;
12. Closing, by the mortgage module, a mortgage agreement determined by at least one of the borrower interface module, the funding partner module, and the mortgage originating institution module, the mortgage agreement comprising:
   a. a risk reduction mortgage, wherein the risk reduction mortgage comprises a first mortgage and a second mortgage;
   b. a servicing addendum requiring at least one of the following:
      i. the servicing of the first mortgage and the second mortgage to be tied together in the risk reduction mortgage;
      ii. the servicing of the first mortgage and the second mortgage cannot be separated;
      iii. an origination data and a servicing data, further comprising at least one of the following:
         1. wherein the origination data is determined at the loan origination;
         2. wherein the servicing data is determined monthly;
13. Managing, by the mortgage module, a payment by the borrower interface module to the second mortgage balance of the risk reduction swap module;
   a. Wherein the payment is accepted in the event of at least one of the following:
      i. Mandatory settlement of the risk reduction mortgage;
      ii. At the request of the borrower interface module;
      iii. As part of a monthly payment of the risk reduction mortgage;
   b. Wherein the payment comprises at least one of: an origination fee, a risk reduction mortgage origination fee, and a fee;
14. Transmitting, by the mortgage module, to the swap servicer module at least one of the following:
   a. the mortgage agreement;
   b. a first mortgage note;
   c. a risk reduction swap agreement;
   d. a second mortgage note;
   e. an evidence of recording;
   f. a servicing addendum;
   g. an origination fee;
   h. a risk reduction mortgage origination fee;
   i. a fee;
   j. a property value;
   k. an appraised property value;
15. Transmitting, by the mortgage servicer module, to the swap servicer module a servicing data;
16. Receiving, by the swap servicer module, at least one of the following:
   a. the mortgage agreement;
   b. a first mortgage note;
   c. a risk reduction swap agreement;
   d. a second mortgage note;
   e. an evidence of recording;
   f. a servicing addendum;
   g. an origination fee;
   h. a risk reduction mortgage origination fee; and
   i. a fee;
   j. a servicing data;
   k. a property value;
   l. an appraised property value;
17. Confirming, by the swap servicer module, receipt of at least one of the following:
   a. the mortgage agreement;
   b. a first mortgage note;
   c. a risk reduction swap agreement;
   d. a second mortgage note;
   e. an evidence of recording;
   f. a servicing addendum;
   g. an origination fee;
   h. a risk reduction mortgage origination fee; and
   i. a fee;
   j. a servicing data;
   k. a property value;
   l. an appraised property value;
18. Updating, by the risk reduction mortgage module, an HPI data,
   a. Wherein the HPI data is retrieved from a HPI module;
   b. Wherein the HPI data is located in the HPI database of the risk reduction mortgage module;
   c. wherein the HPI data is at least one of the following:
      i. A local HPI data;
      ii. A national HPI data;
      iii. A stored local HPI data;
      iv. A stored national HPI;
      v. A real-time local HPI data;
      vi. A real-time national HPI data;
      vii. A prior local HPI data;
      viii. A prior national HPI;
      ix. A mean HPI data;
         1. Wherein the mean is based on a calculation of one or more of: a local HPI data, a national HPI data, a prior mean HPI data;
19. Validating, by the swap servicer module, to the swap servicer module at least one of the following:
   a. A servicing data;
      i. Wherein the servicing data comprises at least one of the following:
         1. the mortgage agreement;
         2. a first mortgage note;
         3. a risk reduction swap agreement;
         4. a second mortgage note;
         5. an evidence of recording;
         6. a servicing addendum;
         7. an origination fee;
         8. a risk reduction mortgage origination fee; and
         9. a fee;
         10. a property value;
         11. an appraised property value;
20. Providing, by the swap servicer module, at least one of the following:
   a. An original property balance;
   b. A risk reduction swap value;
   c. An original local HPI data;
   d. An original national HPI data;
   e. A prior local HPI data;
   f. A prior national HPI data;
   g. A current local HPI data;
   h. A current national HPI data;
   i. A prior second mortgage balance;
   j. A current second mortgage balance;
   k. A prior first mortgage balance;
   l. A current first mortgage balance;
   m. A first mortgage balance;
   n. A second mortgage balance;
   o. A first second mortgage balance;
   p. A second second mortgage balance;
   q. A first first mortgage balance; and
   r. A second first mortgage balance;
   s. a property value;
   t. an appraised property value;
21. Transmitting, by the swap servicer module, to the risk reduction mortgage module at least one of the following:
   a. A servicing data;
      i. Wherein the servicing data comprises at least one of the following:
         1. the mortgage agreement;
         2. a first mortgage note;
         3. a risk reduction swap agreement;
         4. a second mortgage note;
         5. an evidence of recording;
         6. a servicing addendum;
         7. an origination fee;
         8. a risk reduction mortgage origination fee; and
         9. a fee;
         10. a prior second mortgage balance;
         11. a second mortgage balance;
         12. a risk reduction swap value;
         13. a prior risk reduction swap value;
         14. a first mortgage balance;
         15. a property value;
         16. an appraised property value;
   b. a mortgage servicer module report;
      i. Wherein the mortgage servicer module report comprises at least one of the following:
         1. a monthly settlement statement;
         2. a summary portfolio;
         3. a funding partner module report;
         4. a mortgage servicing portfolio;
   c. a risk reduction mortgage notification;
      i. Wherein the risk reduction mortgage notification is triggered based on a determination;
      ii. Wherein the determination is based on at least one of the following:
         1. a sum of the first mortgage balance and the second mortgage balance being less than zero;
         2. a sum of the first mortgage balance and the second mortgage balance being equal to zero;
   d. a funding partner module report;
      i. Wherein the funding partner module report comprises at least one of the following:
         1. a monthly settlement statement;
         2. a summary portfolio;
         3. a funding partner module report;
         4. a mortgage servicing portfolio;
22. Receiving, by the risk reduction mortgage module, at least one of the following:
   a. the mortgage agreement;
   b. a first mortgage note;
   c. a risk reduction swap agreement;
   d. a second mortgage note;
   e. an evidence of recording;
   f. a servicing addendum;
   g. an origination fee;
   h. a risk reduction mortgage origination fee; and
   i. a fee;
   j. a risk reduction swap value;
   k. a first mortgage balance;
   l. a second mortgage balance;
   m. a funding partner module report;
   n. a mortgage servicer module report;
   o. a servicing data;
   p. a property value;
   q. an appraised property value;
   r. a risk reduction mortgage notification; and
   s. a data.
23. Confirming, by the risk reduction mortgage module, receipt of at least one of the following:
   a. the mortgage agreement;
   b. a first mortgage note;
   c. a risk reduction swap agreement;
   d. a second mortgage note;
   e. an evidence of recording;
   f. a servicing addendum;
   g. an origination fee;
   h. a risk reduction mortgage origination fee; and
   i. a fee;
   j. a risk reduction swap value;
   k. a first mortgage balance;
   l. a second mortgage balance;
   m. a funding partner module report;
   n. a mortgage servicer module report;
   o. a servicing data;
   p. a property value;
   q. an appraised property value;
   r. a risk reduction mortgage notification; and
   s. a data.
24. Terminating, by the risk reduction mortgage module, a risk reduction mortgage based on at least one of the following:
   1. a sum of the first mortgage balance and the second mortgage balance being less than zero;
   2. a sum of the first mortgage balance and the second mortgage balance being equal to zero;
   3. the risk reduction swap is one of: a negative value and a zero value;
   4. Variation 1:
      Wherein the terminating, by the risk reduction mortgage module, a risk reduction mortgage is based on a sale of the property, wherein the sale comprises at least one of:
      i. A property value;
      ii. A payoff quote;
      iii. An appraised property value;
      iv. The mortgage servicer module configured to determine a payoff quote of the risk reduction mortgage;
         1. Wherein the payoff quote is determined from the first mortgage balance and the second mortgage balance;
         2. Wherein the swap servicer module is configured to
         a. Receive a settlement fund from a closing agent;
         b. Transfer the settlement fund from the funding partner module when it is determined the second mortgage balance has a negative value;
         c. Transfer the settlement fund to the funding partner module when it is determined the second mortgage has a positive value;
         d. Update the risk reduction mortgage module, wherein updating the risk reduction mortgage module includes notifying the risk reduction module that the risk reduction mortgage has been terminated;
   5. Variation 2:
      Wherein the terminating, by the risk reduction mortgage module, a risk reduction mortgage is based on a refinancing of the first mortgage, wherein the refinancing comprises at least one of:
      i. A property value;
      ii. A payoff quote;
      iii. An appraised property value;
      iv. A refinance mortgage;
      v. The mortgage servicer module configured to determine a payoff quote of the risk reduction mortgage;
         1. Wherein the payoff quote is determined from the first mortgage balance and the second mortgage balance;
         2. Wherein the swap servicer module is configured to:
         a. Receive a settlement fund from the refinance mortgage;
         b. Transfer the settlement fund from the funding partner module when it is determined the second mortgage balance has a negative value;
         c. Transfer the settlement fund to the funding partner module when it is determined the second mortgage has a positive value;
         d. Update the risk reduction mortgage module, wherein updating the risk reduction mortgage module includes notifying the risk reduction module that the risk reduction mortgage has been terminated;
   6. Variation 3:
      Wherein the terminating, by the risk reduction mortgage module, a risk reduction mortgage is based on determining a settlement sum, wherein the settlement sum is at least one of:
      1. a sum of the first mortgage balance and the second mortgage balance being less than zero;
      2. a sum of the first mortgage balance and the second mortgage balance being equal to zero;
      3. a sum of the first mortgage balance and the second mortgage balance is one of: a negative value and a zero value;
      ii. The mortgage servicer module configured to:
      1. determine if the negative value of the second mortgage balance is one of:
         a. Greater than the first mortgage balance;
         b. Equal to the first mortgage balance;
      2. Receive a settlement fund from the swap servicer module when it is determined the second mortgage balance has a negative value;
      3. Transfer the settlement fund to at least one of: the funding partner module, the swap servicer module, and the risk reduction module;
      4. Update the risk reduction mortgage module, wherein updating the risk reduction mortgage module includes notifying the risk reduction module that the risk reduction mortgage has been terminated;
   7. Variation 4:
      Wherein the terminating, by the risk reduction mortgage module, a risk reduction mortgage is based on a repayment of the risk reduction mortgage at completion of the term;
      a. Further comprising wherein the risk reduction module is configured to:
         i. Receive the servicing data from the swap servicer module;
         1. Wherein the servicing data includes a payment from the borrower interface module;
         ii. manage the risk reduction mortgage such that the first mortgage balance and the second mortgage balance are paid concurrently;
         iii. determine the first mortgage balance and the second mortgage balance have at least one of: a negative value, a zero value;
         iv. Update the risk reduction mortgage module, wherein updating the risk reduction mortgage module includes notifying the risk reduction module that the risk reduction mortgage has been terminated;
   8. Variation 5:
      Wherein the terminating, by the risk reduction mortgage module, a risk reduction mortgage is based on a repayment of the risk reduction mortgage at completion of the term;
      a. Further comprising wherein the risk reduction module is configured to:
         i. Receive the servicing data from the swap servicer module;
         1. Wherein the servicing data includes a payment from the borrower interface module;
      ii. manage the risk reduction mortgage such that the first mortgage balance is a zero value before applying the payment to the second mortgage balance;
      iii. determine the first mortgage balance and the second mortgage balance have at least one of: a negative value, a zero value;
      iv. Update the risk reduction mortgage module, wherein updating the risk reduction mortgage module includes notifying the risk reduction module that the risk reduction mortgage has been terminated;

Although the stages are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the without altering or deterring from the fundamental scope of the depicted methods and systems disclosed herein.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

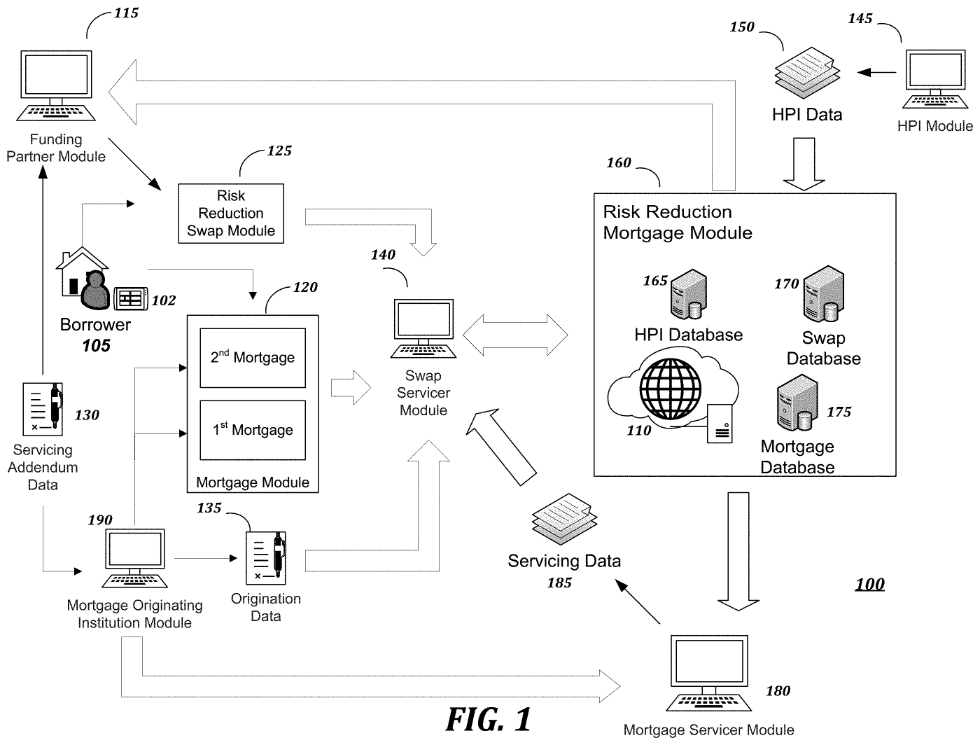

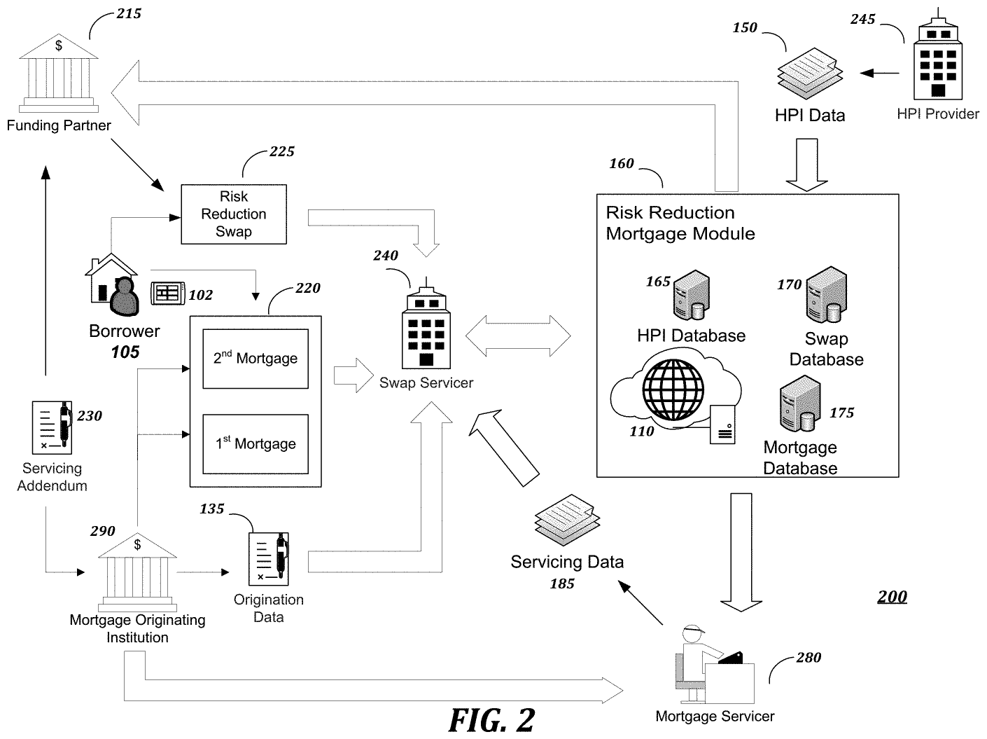

FIGS. 1 and 2 illustrate non-limiting examples of operating environments for the aforementioned modules. Although modules are disclosed with specific functionality, it should be understood that functionality may be shared between modules, with some functions split between modules, while other functions duplicated by the modules. Furthermore, the name of the module should not be construed as limiting upon the functionality of the module. Moreover, each stage in the claim language can be considered independently without the context of the other stages. Each stage may contain language defined in other portions of this specification. Each stage disclosed for one module may be mixed with the operational stages of another module. Each stage can be claimed on its own and/or interchangeably with other stages of other modules. The following claims will detail the operation of each module, and inter-operation between modules.

I. Embodiments of the present disclosure provide a software and hardware platform comprised of a distributed set of modules, including, but not limited to:
A. A Borrower Interface module 102;
B. A Mortgage Originating Institution module 190;
C. A Funding Partner module 115;
D. A Risk Reduction Swap module 125;
E. A Swap Servicer module 140;
F. A Mortgage module 120;
G. A Mortgage Servicer module 180;
H. A HPI module 145; and
I. A Risk Reduction Mortgage module 160.

In some embodiments, the present disclosure may provide an additional set of modules for further facilitating the software and hardware platform. The additional set of modules may comprise, but not be limited to:
J. Origination Module;
K. Closing Module;
L. Post-Closing Module;
M. Monthly Servicing Module; and
N. Swap Settlement Module.

II. Embodiments of the present disclosure provide a software and hardware platform comprised of a distributed set of computing elements, including, but not limited to:

A. A Computing Device

Reference 600

The computing device comprising, but not limited to at least one of the following:
A processing unit,
A memory storage,

Wherein the computing device may be embodied as a mobile computing device,
wherein the mobile computing device comprises, but is not limited to,
   A tablet,
   A smartphone,
   A laptop, and
   A remotely operable device;

Wherein the computing device may be embodied as any of the computing elements illustrated in FIG. 1, including, but not limited to, Borrower Interface Module 102, Mortgage Module 120, Mortgage Originating Institution Module 190; Funding Partner Module 115; Swap Servicer Module 140; Mortgage Servicer Module 180; HPI Module 145; and Risk Reduction Mortgage Module 160.

B. Modules Associated with the Computing Device

Platform may be operative to control at least one of the following sub-modules of a computing device:
A user interface module,
A Borrower Interface module,
A Mortgage Originating Institution module,
A Funding Partner module,
A Risk Reduction Swap module,
A Swap Servicer module,
A Mortgage module,
A Mortgage Servicer module,
A HPI module,
A Risk Reduction Mortgage module, and
A communications module.

1. The User Interface Module
a. Enables user-control of the Computing Device
b. Enables user-control of the Modules of the Computing Device
   i. The user interface module
   ii. The borrower interface module
   iii. The risk reduction mortgage module
   iv. The communications module
   v. The mortgage originating institution module,
   vi. The funding partner module,
   vii. The risk reduction swap module,
   viii. The swap servicer module,
   ix. The mortgage module,
   x. The mortgage servicer module,
   xi. The HPI module,
c. Enables user-control of the Platform Modules:
   i. The risk reduction mortgage generation module
   ii. The risk reduction mortgage transmission module
   iii. The risk reduction mortgage organization module
   iv. The risk reduction mortgage display module

2. The Borrower Interface Module
a. Generating a risk reduction mortgage;
b. Providing a payment interface to the borrower to submit payments wherein payments are one of a monthly payment or a one-time payment;
c. Providing a summary balance interface to the borrower wherein the summary balance interface displays at least one of a first mortgage balance, a second mortgage balance, a risk reduction mortgage balance;
d. Providing a mortgage servicing interface wherein the mortgage servicing interface displays at least one of a funding partner, a mortgage originating institution, a local HPI, a national HPI, an origination data, a swap servicer, a servicing addendum, a servicing data, and an HPI data.

3. The Mortgage Originating Institution Module
a. Generating a new mortgage wherein the new mortgage is at least one of: a conventional mortgage transaction, a purchase money mortgage transaction, and a refinance mortgage transaction;
b. Wherein the new mortgage comprises a property value;
c. Determining whether the new mortgage is eligible to become a risk reduction mortgage;
   i. Wherein determining is based on the new mortgage comprising at least one of the following:
      1. A conventional mortgage;
      2. requiring monthly payments;
      3. having a term at least one of:
         a. 120 months;
         b. Greater than 120 months;
         c. Less than 360 months;
         d. 360 months;
d. A first mortgage wherein the first mortgage is a conventional mortgage requiring a monthly payment for the duration of the term;
e. A second mortgage;
   i. Wherein the second mortgage is tied to the first mortgage in a risk reduction swap;

4. The Risk Reduction Swap Module
a. Entering a risk reduction swap transaction with a funding partner module;
   i. Wherein the risk reduction swap transaction swaps a local real estate market price risk for a national real estate price risk;
   ii. Wherein the risk reduction swap transaction changes relative to at least one of a local HPI data and a national HPI data;
      1. Wherein the relative change is determined by a comparison of a first mortgage balance and an estimated current property value;
         a. Wherein the estimated current property value is the product of an appraised property value at a loan origination and one plus a percentage change in the local HPI since the loan origination;
         b. Wherein the estimated current property value is the product of an appraised property value at the loan origination and one plus a percentage change in the national HPI since the loan origination;
      2. Wherein the risk reduction swap transaction is stored in the risk reduction swap module;
      3. Wherein the risk reduction swap transaction is a non-tradeable private swap;
      4. Wherein the risk reduction swap is either positive, negative, or zero;
      5. Wherein an initial risk reduction swap value is a zero dollar value.
b. Determining, by the risk reduction swap module, a risk reduction swap value;
   i. Wherein the risk reduction swap value is determined monthly;
   ii. Wherein the risk reduction swap value is determined based on changes to the local HPI and national HPI in a prior month respective to stored local HPI and national HPI data;
   iii. Wherein the local HPI and national HPI data is retrieved from a HPI module;
   iv. Wherein the stored local HPI and national data is located in the HPI database of the risk reduction mortgage module;
c. Determining, by the risk reduction swap module, a termination of the risk reduction swap upon the occurrence of at least one of;
   i. A sale of the property;
   ii. A transfer of the property;
   iii. A refinance of the first mortgage;
      1. Whenever the sum of the first mortgage and second mortgage is equal to one of: less than zero or zero;

5. The Funding Partner Module
a. Securing, by a funding partner module, the risk reduction swap provided, by the risk reduction swap module;
   i. Wherein securing comprises an open-end second mortgage;
   ii. Wherein securing comprises the funding partner module determining ownership of the open-end second mortgage;
      1. Wherein determining ownership includes assigning ownership to one of the funding partner module or a designee of the funding partner module;
   iii. Wherein securing comprises a second mortgage;

6. The Mortgage Module
a. Setting, by a mortgage module, a second mortgage balance;
   i. Wherein the second mortgage balance is a determined value;
   ii. Wherein the second mortgage balance is initially zero;
   iii. Wherein the second mortgage comprises a determined interest rate;
      1. Wherein the determined interest rate is zero;
      2. Wherein the determined interest rate is a fixed rate;
      3. Wherein the determined interest rate is equal to a five-year treasury yield plus a margin;
b. Increasing the second mortgage balance by an amount equal to a calculated increase in the risk reduction swap value in a prior month;
   i. Wherein the increase is a result of a settlement of the risk reduction swap;
c. Decreasing the second mortgage balance by an amount equal to a calculated decrease in the risk reduction swap value in a prior month;
   i. Wherein the decrease is a result of a settlement of the risk reduction swap;
d. Setting, by the mortgage module, a second mortgage payment;
   i. Wherein the second mortgage payment is determined based on a fully amortized loan at the determined interest rate and a term;
   ii. Wherein the term is a number of years;
   iii. Wherein the number of years is determined by a calculation based on the second mortgage balance and the determined interest rate;
e. Closing, by the mortgage module, a mortgage agreement determined by at least one of the borrower interface module, the funding partner module, and the mortgage originating institution module, the mortgage agreement comprising:
   i. a risk reduction mortgage, wherein the risk reduction mortgage comprises a first mortgage and a second mortgage;
   ii. a servicing addendum requiring at least one of the following:
      1. the servicing of the first mortgage and the second mortgage to be tied together in the risk reduction mortgage;
      2. the servicing of the first mortgage and the second mortgage cannot be separated;
      3. an origination data and a servicing data, further comprising at least one of the following:
         a. wherein the origination data is determined at the loan origination;
         b. wherein the servicing data is determined monthly;
f. Managing, by the mortgage module, a payment by the borrower interface module to the second mortgage balance of the risk reduction swap module;
   i. Wherein the payment is accepted in the event of at least one of the following:
      1. Mandatory settlement of the risk reduction mortgage;
      2. At the request of the borrower interface module;
      3. As part of a monthly payment of the risk reduction mortgage;
   ii. Wherein the payment comprises at least one of: an origination fee, a risk reduction mortgage origination fee, and a fee;
g. Transmitting, by the mortgage module, to the swap servicer module at least one of the following:
   i. the mortgage agreement;
   ii. a first mortgage note;
   iii. a risk reduction swap agreement;
   iv. a second mortgage note;
   v. an evidence of recording;
   vi. a servicing addendum;
   vii. an origination fee;
   viii. a risk reduction mortgage origination fee;
   ix. a fee;
   x. a property value;
   xi. an appraised property value;
h. Transmitting, by the mortgage servicer module, to the swap servicer module a servicing data;

7. The Swap Servicer Module
i. Receiving, by the swap servicer module, at least one of the following:
   a. the mortgage agreement;
   b. a first mortgage note;
   c. a risk reduction swap agreement;
   d. a second mortgage note;
   e. an evidence of recording;
   f. a servicing addendum;
   g. an origination fee;
   h. a risk reduction mortgage origination fee; and
   i. a fee;
   j. a servicing data;
   k. a property value;
   l. an appraised property value;
ii. Confirming, by the swap servicer module, receipt of at least one of the following:
   a. the mortgage agreement;
   b. a first mortgage note;
   c. a risk reduction swap agreement;
   d. a second mortgage note;
   e. an evidence of recording;
   f. a servicing addendum;
   g. an origination fee;
   h. a risk reduction mortgage origination fee; and
   i. a fee;
   j. a servicing data;
   k. a property value;
   l. an appraised property value;
iii. Updating, by the risk reduction mortgage module, an HPI data,
   a. Wherein the HPI data is retrieved from a HPI module;
b. Wherein the HPI data is located in the HPI database of the risk reduction mortgage module;
c. wherein the HPI data is at least one of the following:
   i. A local HPI data;
   ii. A national HPI data;
   iii. A stored local HPI data;
   iv. A stored national HPI;
   v. A real-time local HPI data;
   vi. A real-time national HPI data;
   vii. A prior local HPI data;
   viii. A prior national HPI;
   ix. A mean HPI data;
      1. Wherein the mean is based on a calculation of one or more of: a local HPI data, a national HPI data, a prior mean HPI data;
iv. Validating, by the swap servicer module, to the swap servicer module at least one of the following:
   a. A servicing data;
      i. Wherein the servicing data comprises at least one of the following:
         1. the mortgage agreement;
         2. a first mortgage note;
         3. a risk reduction swap agreement;
         4. a second mortgage note;
         5. an evidence of recording;
         6. a servicing addendum;
         7. an origination fee;
         8. a risk reduction mortgage origination fee; and
         9. a fee;
         10. a property value;
         11. an appraised property value;
v. Providing, by the swap servicer module, at least one of the following:
   a. An original property balance;
   b. A risk reduction swap value;
   c. An original local HPI data;
   d. An original national HPI data;
   e. A prior local HPI data;
   f. A prior national HPI data;
   g. A current local HPI data;
   h. A current national HPI data;
   i. A prior second mortgage balance;
   j. A current second mortgage balance;
   k. A prior first mortgage balance;
   l. A current first mortgage balance;
   m. A first mortgage balance;
   n. A second mortgage balance;
   o. A first second mortgage balance;
   p. A second second mortgage balance;
   q. A first first mortgage balance; and
   r. A second first mortgage balance;
   s. a property value;
   t. an appraised property value;
vi. Transmitting, by the swap servicer module, to the risk reduction mortgage module at least one of the following:
   a. A servicing data;
      i. Wherein the servicing data comprises at least one of the following:
         1. the mortgage agreement;
         2. a first mortgage note;
         3. a risk reduction swap agreement;
         4. a second mortgage note;
         5. an evidence of recording;
         6. a servicing addendum;
         7. an origination fee;
         8. a risk reduction mortgage origination fee; and
         9. a fee;
         10. a prior second mortgage balance;
         11. a second mortgage balance;
         12. a risk reduction swap value;
         13. a prior risk reduction swap value;
         14. a first mortgage balance;
         15. a property value;
         16. an appraised property value;
   b. a mortgage servicer module report;
      i. Wherein the mortgage servicer module report comprises at least one of the following:
         1. a monthly settlement statement;
         2. a summary portfolio;
         3. a funding partner module report;
         4. a mortgage servicing portfolio;
   c. a risk reduction mortgage notification;
      i. Wherein the risk reduction mortgage notification is triggered based on a determination;
      ii. Wherein the determination is based on at least one of the following:
         1. a sum of the first mortgage balance and the second mortgage balance being less than zero;
         2. a sum of the first mortgage balance and the second mortgage balance being equal to zero;
   d. a funding partner module report;
      i. Wherein the funding partner module report comprises at least one of the following:
         1. a monthly settlement statement;
         2. a summary portfolio;
         3. a funding partner module report;
         4. a mortgage servicing portfolio;
e. Wherein the swap servicer module is configured to:
   i. Receive a settlement fund from a closing agent;
   ii. Transfer the settlement fund from the funding partner module when it is determined the second mortgage balance has a negative value;
   iii. Transfer the settlement fund to the funding partner module when it is determined the second mortgage has a positive value;
   iv. Update the risk reduction mortgage module, wherein updating the risk reduction mortgage module includes notifying the risk reduction module that the risk reduction mortgage has been terminated;

8. The Mortgage Servicer Module
a. The mortgage servicer module configured to determine a payoff quote of the risk reduction mortgage;
   i. Wherein the payoff quote is determined from the first mortgage balance and the second mortgage balance;

9. The HPI Module
a. Updating an HPI data,
   i. Wherein the HPI data is retrieved from a HPI module;
   ii. Wherein the HPI data is located in the HPI database of the risk reduction mortgage module;
   iii. wherein the HPI data is at least one of the following:
      1. A local HPI data;
      2. A national HPI data;
      3. A stored local HPI data;
      4. A stored national HPI;
      5. A real-time local HPI data;
      6. A real-time national HPI data;
      7. A prior local HPI data;
      8. A prior national HPI;
      9. A mean HPI data;
         a. Wherein the mean is based on a calculation of one or more of: a local HPI data, a national HPI data, a prior mean HPI data;
      iv. determining based on changes to the local HPI and national HPI in a prior month respective to stored local HPI and national HPI data;
      v. Wherein the local HPI and national HPI data is retrieved from a HPI module;
      vi. Wherein the stored local HPI and national data is located in the HPI database of the risk reduction mortgage module;

10. The Risk Reduction Mortgage Module
a. Receiving, by the risk reduction mortgage module, at least one of the following:
   i. the mortgage agreement;
   ii. a first mortgage note;
   iii. a risk reduction swap agreement;
   iv. a second mortgage note;
   v. an evidence of recording;
   vi. a servicing addendum;
   vii. an origination fee;
   viii. a risk reduction mortgage origination fee; and
   ix. a fee;
   x. a risk reduction swap value;
   xi. a first mortgage balance;
   xii. a second mortgage balance;
   xiii. a funding partner module report;
   xiv. a mortgage servicer module report;
   xv. a servicing data;
   xvi. a property value;
   xvii. an appraised property value;
   xviii. a risk reduction mortgage notification; and
   xix. a data.
b. Confirming, by the risk reduction mortgage module, receipt of at least one of the following:
   i. the mortgage agreement;
   ii. a first mortgage note;
   iii. a risk reduction swap agreement;
   iv. a second mortgage note;
   v. an evidence of recording;
   vi. a servicing addendum;
   vii. an origination fee;
   viii. a risk reduction mortgage origination fee; and
   ix. a fee;
   x. a risk reduction swap value;
   xi. a first mortgage balance;
   xii. a second mortgage balance;
   xiii. a funding partner module report;
   xiv. a mortgage servicer module report;
   xv. a servicing data;
   xvi. a property value;
   xvii. an appraised property value;
   xviii. a risk reduction mortgage notification; and
   xix. a data.
c. Terminating, by the risk reduction mortgage module, a risk reduction mortgage based on at least one of the following:
   a. a sum of the first mortgage balance and the second mortgage balance being less than zero;
   b. a sum of the first mortgage balance and the second mortgage balance being equal to zero;
   c. the risk reduction swap is one of: a negative value and a zero value;
   d. Wherein the terminating, by the risk reduction mortgage module, a risk reduction mortgage is based on a sale of the property;
   e. Wherein the terminating, by the risk reduction mortgage module, a risk reduction mortgage is based on a refinancing of the first mortgage;
   f. Wherein the terminating, by the risk reduction mortgage module, a risk reduction mortgage is based on determining a settlement sum;
   g. Wherein the terminating, by the risk reduction mortgage module, a risk reduction mortgage is based on a repayment of the risk reduction mortgage at completion of the term;
   h. Wherein the terminating, by the risk reduction mortgage module, a risk reduction mortgage is based on a repayment of the risk reduction mortgage at completion of the term;

Various hardware components may be used at the various stages of operations follow the method and computer-readable medium. For example, although the methods have been described to be performed by a computing device, it should be understood that, in some embodiments, different operations may be performed by different networked elements in operative communication with the computing device. For example, server 110 and/or computing device 600 may be employed in the performance of some or all of the stages disclosed with regard to the methods below.

Embodiments of the present disclosure provide a hardware and software platform operative by a set of methods and computer-readable media comprising instructions configured to operate the aforementioned modules and computing elements in accordance with the aforementioned methods.

The methods and computer-readable media may comprise a set of instructions which when executed are configured to enable a method for inter-operating the aforementioned modules may be inter-operated to perform a method comprising various stages.

### III. Platform Operation

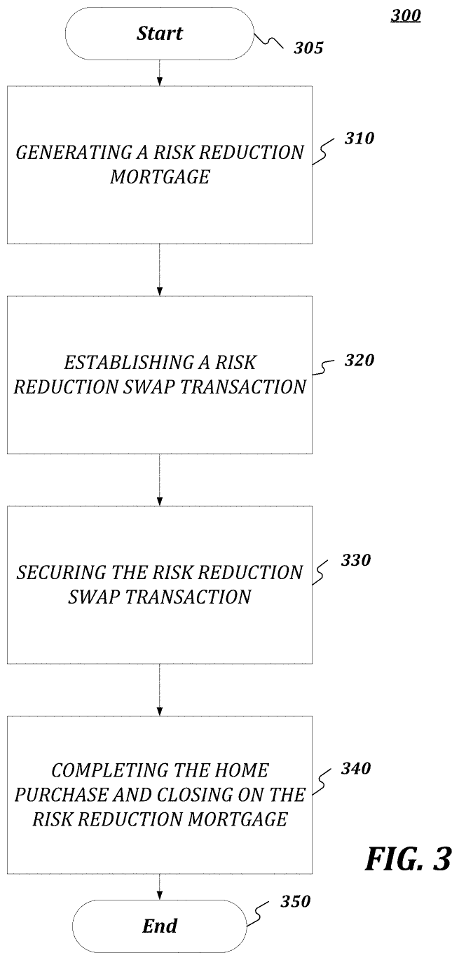

FIG. 3 is a flow chart setting forth the general stages involved in a method 300 consistent with an embodiment of the disclosure for providing a risk reduction mortgage platform 100. Method 300 may be implemented using a computing device 600 as described in more detail below with respect to FIG. 6.

Although method 300 has been described to be performed by computing device 600, it should be understood that, in some embodiments, different operations may be performed by different networked elements in operative communication with computing device 600. For example, server 110 and/or computing device 600 may be employed in the performance of some or all of the stages in method 300. Moreover, server 110 may be configured much like computing device 600 and, in some instances, be one and the same embodiment. Similarly, apparatus 160 may be employed in the performance of some or all of the stages in method 300. Apparatus 160 may also be configured much like computing device 600.

Although method 300 has been described to be performed by platform 100, it should be understood that computing device 600 may be used to perform the various stages of method 300. Furthermore, in some embodiments, different operations may be performed by different networked elements in operative communication with computing device 600. For example, server 110 may be employed in the performance of some or all of the stages in method 300. Moreover, server 110 may be configured much like computing device 600. Similarly, apparatus 160 may be employed in the performance of some or all of the stages in method 300. Apparatus 160 may also be configured much like computing device 600.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 300 will be described in greater detail below.

Method 300 may begin at starting block 305 and proceed to stage 310 where computing device 600 may generate a risk reduction mortgage. In general, the first flow chart describes an embodiment of the disclosure in terms of computing device 600, programming modules 606 (i.e. Risk Reduction Mortgage application 620), and the method claim set.

From stage 310, where computing device 600 may generate a risk reduction mortgage, method 300 may advance to stage 320 where computing device 600 may establish a risk reduction swap transaction.

Once computing device 600 establishes a risk reduction swap transaction in stage 320, method 300 may continue to stage 330 where computing device 600 may secure the risk reduction swap transaction.

After computing device 600 securing the risk reduction swap transaction in stage 330, method 300 may proceed to stage 340 where computing device 600 may complete the closing process on the risk reduction mortgage. Once computing device 600 completes the closing process on the risk reduction mortgage in stage 340, method 300 may then end at stage 350.

Method 400 may begin at starting block 405 and proceed to stage 410 where computing device 600 may provide a payment interface using the borrower interface module. In general, the first flow chart describes an embodiment of the disclosure in terms of computing device 600, programming modules 606 (i.e. Risk Reduction Mortgage application 620), and the method claim set.

From stage 410, where computing device 600 provides a payment interface using the borrower interface module, method 400 may advance to stage 420 where computing device 600 may establish an agreement between a funding partner module and a mortgage originating institution module.

Once computing device 600 establishes an agreement between a funding partner module and a mortgage originating institution module in stage 420, method 400 may continue to stage 430 where computing device 600 may manage mortgage payments from the borrower interface module using the swap servicer module and mortgage servicer module.

After computing device 600. manages mortgage payments from the borrower interface module using the swap servicer module and mortgage servicer module in stage 430, method 400 may proceed to stage 440 where computing device 600 may manage, analyze, and update the risk reduction mortgage module. Once computing device 600 manages, analyzes, and updates the risk reduction mortgage module in stage 440, method 400 may then end at stage 450.

Method 500 may begin at starting block 505 and proceed to stage 510 where computing device 600 may determine if the property has been sold. In general, the first flow chart describes an embodiment of the disclosure in terms of computing device 600, programming modules 606 (i.e. Risk Reduction Mortgage application 620), and the method claim set.

From stage 510, where computing device 600 determines if the property has been sold, method 500 may advance to stage 520 where computing device 600 may determine if the first mortgage has been refinanced.

Once computing device 600 determines if the first mortgage has been refinanced in stage 520, method 500 may continue to stage 530 where computing device 600 may determine if the sum of the first mortgage and the second mortgage is less than or equal to zero.

After computing device 600 determining if the sum of the first mortgage and the second mortgage is less than or equal to zero. in stage 530, method 500 may proceed to stage 540 where computing device 600 may terminate the risk reduction mortgage. For example, settling all of the mortgage balances and liens associated with the property relating to the risk reduction mortgage. Once computing device 600 terminates the risk reduction mortgage in stage 540, method 500 may then end at stage 550.

### IV. Computing Device Architecture

The risk reduction mortgage platform 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, the risk reduction mortgage platform 100 may be hosted on a centralized server, such as, for example, a cloud computing service. Although method 300 has been described to be performed by a computing device 600, it should be understood that, in some embodiments, different operations may be performed by different networked elements in operative communication with computing device 600.

Embodiments of the present disclosure may comprise a system having a memory storage and a processing unit. The processing unit coupled to the memory storage, wherein the processing unit is configured to perform the stages of method 300.

FIG. 6 is a block diagram of a system including computing device 600. Consistent with an embodiment of the disclosure, the aforementioned memory storage and processing unit may be implemented in a computing device, such as computing device 600 of FIG. 6. Any suitable combination of hardware, software, or firmware may be used to implement the memory storage and processing unit. For example, the memory storage and processing unit may be implemented with computing device 600 or any of other computing devices 618, in combination with computing device 600. The aforementioned system, device, and processors are examples and other systems, devices, and processors may comprise the aforementioned memory storage and processing unit, consistent with embodiments of the disclosure.

With reference to FIG. 6, a system consistent with an embodiment of the disclosure may include a computing device, such as computing device 600. In a basic configuration, computing device 600 may include at least one processing unit 602 and a system memory 604. Depending on the configuration and type of computing device, system memory 604 may comprise, but is not limited to, volatile (e.g. random access memory (RAM)), nonvolatile (e.g. read-only memory (ROM)), flash memory, or any combination. System memory 604 may include operating system 605, one or more programming modules 606, and may include a program data 607. Operating system 605, for example, may be suitable for controlling computing device 600's operation. In one embodiment, programming modules 606 may include a Borrower Interface module 102, a Mortgage Originating Institution module 190, a Funding Partner module 115, a Risk Reduction Swap module 125, a Swap Servicer module 140, a Mortgage module 120, a Mortgage Servicer module 180, a HPI module 145; and a Risk Reduction Mortgage module 160, and other programming modules that may enable the disclosure, for example Risk Reduction Mortgage application 620>. Furthermore, embodiments of the disclosure may be practiced in conjunction with a graphics library, other operating systems, or any other application program and is not limited to any particular application or system. This basic configuration is illustrated in FIG. 6 by those components within a dashed line 608.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and nonvolatile, removable and non-removable media implemented in any method or technology for storage of information, such as computer readable instructions, data structures, program modules, or other data. System memory 604, removable storage 609, and non-removable storage 610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 612 such as a keyboard, a mouse, a pen, a sound input device, a touch input device, etc. Output device(s) 614 such as a display, speakers, a printer, etc. may also be included. The aforementioned devices are examples and others may be used.

Computing device 600 may also contain a communication connection 616 that may allow device 600 to communicate with other computing devices 618, such as over a network in a distributed computing environment, for example, an intranet or the Internet. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 604, including operating system 605. While executing on processing unit 602, programming modules 606 (e.g., Risk Reduction Mortgage application 620) may perform processes including, for example, one or more of method 300's stages as described above. The aforementioned process is an example, and processing unit 602 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and quantum computing elements. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

### V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method comprising:
generating a risk reduction mortgage by at least one of:
a borrower interface module;
a mortgage module;
a mortgage originating institution module;
a funding partner module;
a risk reduction swap module;
a swap servicer module;
a mortgage servicer module; and
a risk reduction mortgage module;
establishing a risk reduction swap transaction with a funding partner module; and
closing on the risk reduction mortgage.

2. The method of claim 1 wherein the risk reduction mortgage comprises:
a term of at least one of:
120 months;
Greater than 120 months;
Less than 360 months;
360 months;
a first mortgage wherein the first mortgage is a conventional mortgage requiring a monthly payment for a duration of the term;
a second mortgage, wherein the second mortgage is tied to the first mortgage in a risk reduction swap.

3. The method of claim 2 further comprising wherein the risk reduction swap transaction comprises a relative change determined by at least one of a local HPI data and a national HPI data.

4. The method of claim 3 further comprising at least one of:
wherein the relative change is determined by a comparison of a first mortgage balance and an estimated current property value;
wherein the estimated current property value is the mathematical product of an appraised property value at a loan origination and one plus a percentage change in the local HPI since the loan origination;
wherein the estimated current property value is the mathematical product of an appraised property value at the loan origination and one plus a percentage change in the national HPI since the loan origination; and
wherein the risk reduction swap transaction is stored in the risk reduction swap module.

5. The method of claim 3 determining, by the risk reduction swap module, a risk reduction swap value including at least one of the following:
wherein the risk reduction swap value is determined monthly;
wherein the risk reduction swap value is determined based on changes to the local HPI and national HPI in a prior month respective to stored local HPI and national HPI data;
wherein the local HPI and national HPI data is retrieved from a HPI module; and
wherein the stored local HPI and national data is located in an HPI database of the risk reduction mortgage module.

6. The method of claim 5, further comprising determining, by the risk reduction swap module, a termination of the risk reduction swap upon an occurrence of at least one of:
a sale of a property;
a transfer of the property;
a refinance of the first mortgage;
whenever a mathematical sum of the first mortgage and second mortgage is equal to one of: less than zero or zero; and
a completion of payment of the risk reduction mortgage at an end of the term.

7. A system comprising:
a server,
a Borrower Interface module configured to provide a payment interface;
a Mortgage Originating Institution module;
a Funding Partner module;
a Risk Reduction Swap module that creates an agreement between the funding partner module and the mortgage originating institution;
a Mortgage module that manages a first mortgage and a second mortgage for a purchase of a property;
a Mortgage Servicer module that manages a payment from the borrower interface module;
a Swap Servicer module that manages a servicing data from the mortgage servicer module;
an HPI module that updates a local HPI and a national HPI; and
a Risk Reduction Mortgage module that:
generates a risk reduction mortgage;
analyzes the risk reduction mortgage; and
updates the risk reduction mortgage.

8. The system of claim 7 wherein the HPI module updates further comprises at least one of the following: a local HPI, a national HPI, a calculated HPI based on a mathematical calculation using the local HPI and national HPI.

9. The system of claim 7 wherein the risk reduction mortgage module stores and or manage at least one of the following: an HPI database, a swap database, a mortgage database.

10. The system of claim 7 wherein the swap servicer module transmits at least one of the following:
the servicing data, further comprising at least one of the following:
a mortgage agreement,
a first mortgage note,
a risk reduction swap agreement,
a second mortgage note,
an evidence of recording,
a servicing addendum,
an origination fee,
a risk reduction mortgage origination fee, and
a fee,
a prior second mortgage balance,
a second mortgage balance,
a risk reduction swap value,
a prior risk reduction swap value,
a first mortgage balance,
a property value,
an appraised property value;
a mortgage servicer module report;
a risk reduction mortgage notification; and
a funding partner module report.

11. The system of claim 10, wherein the mortgage servicer module report comprises at least one of the following:
a monthly settlement statement;
a summary portfolio;
a funding partner module report; and
a mortgage servicing portfolio.

12. The system of claim 10, wherein the risk reduction mortgage notification is triggered based on a determination; and
wherein the determination is based on at least one of the following:
a sum of the first mortgage balance and the second mortgage balance being less than zero;
a sum of the first mortgage balance and the second mortgage balance being equal to zero.

13. The system of claim 10, wherein the funding partner module report comprises at least one of the following:
a monthly settlement statement;
a summary portfolio;
a funding partner module report; and
a mortgage servicing portfolio.

14. The system of claim 10, wherein the risk reduction mortgage module determines a termination of the risk reduction mortgage upon an occurrence of at least one of:
a sale of the property;
a transfer of the property;
a refinance of the first mortgage;
upon completion of payment of the risk reduction mortgage at an end of the term; and
whenever a mathematical sum of the first mortgage and second mortgage is equal to one of: less than zero and zero.

15. A computer-readable medium, comprising:
a memory;
a processor;
further comprising a set of instructions which when executed is configured to enable a method comprising:
generating a risk reduction mortgage by at least one of:
a borrower interface module;
a mortgage module;
a mortgage originating institution module;
a funding partner module;
a risk reduction swap module;
a swap servicer module;
a mortgage servicer module; and
a risk reduction mortgage module; and
establishing a risk reduction swap transaction with a funding partner module.

16. The computer readable medium of claim 15, determining, by the risk reduction swap module, a risk reduction swap value:
wherein the risk reduction swap value is determined monthly;
wherein the risk reduction swap value is determined based on changes to local HPI and national HPI in a prior month respective to stored local HPI and national HPI data;
wherein the local HPI and national HPI data is retrieved from a HPI module; and
wherein the stored local HPI and national data is located in an HPI database of the risk reduction mortgage module.

17. The computer readable medium of claim 15, further comprising securing, by the funding partner module, the risk reduction swap provided, by the risk reduction swap module:
wherein securing comprises an open-end second mortgage;
wherein securing comprises the funding partner module determining ownership of the open-end second mortgage; and
wherein determining ownership includes assigning ownership to one of the funding partner module or a designee of the funding partner module.

18. The computer readable medium of claim 15, further comprising:
setting, by a mortgage module, a second mortgage balance;
wherein the second mortgage balance is a determined value;
wherein the second mortgage balance is initially zero; and
wherein the second mortgage comprises a determined interest rate, wherein the determined interest rate is at least one of: zero, a fixed rate, and a five-year treasury yield plus a margin.

19. The computer readable medium of claim 16, further comprising at least one of:
increasing a second mortgage balance by an amount equal to a calculated increase in the risk reduction swap value in a prior month,
wherein the increase is a result of a settlement of the risk reduction swap; and
decreasing the second mortgage balance by an amount equal to a calculated decrease in the risk reduction swap value in a prior month,
wherein the decrease is a result of the settlement of the risk reduction swap.

20. The computer readable medium of claim 15, determining, by the risk reduction mortgage module, a termination of the risk reduction swap upon an occurrence of at least one of;
a sale of a property;
a transfer of the property;
a refinance of a first mortgage;
whenever a mathematical sum of the first mortgage and second mortgage is equal to one of: less than zero or zero; and
a completion of payment of the risk reduction mortgage at an end of the term.
